(19) United States
(12) Patent Application Publication
(10) Pub. No.: US 2005/0238783 A1
(43) Pub. Date: Oct. 27, 2005

(54) No-whey process for production of low fat hard cheese

(76) Inventors: Xiao-Qing Han, Naperville, IL (US); Mingxia Liu, Naperville, IL (US)

Correspondence Address: Xiao-Qing Han, 1464 Larsen Court, Naperville, IL, 60563, US

(21) Appl. No.: 10/829,076

(22) Filed: Apr. 22, 2004

(51) Int. Cl. A23C 19/00

(52) U.S. Cl. 426/582

(57) ABSTRACT

The present invention provides a no-whey process for preparing a low-fat hard cheese product with completed capture of whey proteins using a modified milk protein concentrate. The modified milk protein concentrate comprises about 82 to about 96 percent milk protein concentrate and about 4 to about 18 percent multifunctional enzyme, wherein the multifunctional enzyme modifies the function of dairy proteins so that the completed capture of whey proteins into a cheese product will not interfere with the alignment of casein molecules into the fibers structure required for a good texture of hard cheeses such as mozzarella. The present invention solves problems associated with the whey generated from conventional making cheese plant and creates a new way of making low-fat hard cheese products.

### FIELD OF THE INVENTION

The present invention generally relates to a method for preparing hard cheese. Specifically, the present invention relates to a no-whey process for preparing natural hard cheese incorporated with all whey proteins. More specifically, the present invention relates to a no-whey process for preparing a low fat hard cheese using a modified milk protein concentrate.

### BACKGROUND OF THE INVENTION

Hard cheese, such as mozzarella cheese, is one of the most stretched natural cheeses that undergoes a characteristic hot water stretching step to provide both the characteristic oriented fibrous structure and the appropriate melting properties of finished product. Traditionally, mozzarella cheese is made by acidifying either full or reduced fat milk with lactic acid bacterial cultures or vinegar together with a process of proteolysis, typically using rennet or similar enzymes, to form curds and whey. The so formed curd, after separating from the whey, is then processed by a pasta filata system utilizing heat and mechanical working to impart the desirable mozzarella texture. Traditional methods of making natural hard cheese, while producing an excellent finished product, have the disadvantages of being relatively time consuming, getting a very low rate of raw material conversion from which about 90% of milk becomes a processing waste named “whey”, and losing valuable whey proteins. The removal of whey requires further processing for conversion into secondary products or treatment prior to disposal, which add further costs to the product.

In the prior art to produce cheeses from concentrated fluid milk, PCT Patent Publication WO 00/27214 (published May 18, 2000) describes a process to produce cheese by treating whole liquid milk with acid to adjust the pH to about 5 to about 6.8 prior to ultrafiltration and diafiltration. The mixture was then salted and optional enzymes were added. The mixture was incubated for three hours and then transferred to a cooker and mechanically worked. Unsalted butter and milk protein isolate (or calcium caseinate) were added with increased agitation. After adjustment of the pH to about 5, an enzyme modified cheese blend was added for flavor.

It is also well known in the prior art, U.S. Pat. No. 6,372,268 describes a wheyless process for preparing natural mozzarella cheese using dry dairy ingredients. The method comprises mixing water and a dairy fat to form a first blend, adding a lactic acid-producing culture to the first blend to form a second blend, mixing a dry dairy ingredient with the second blend to form a cultured dough, incubating the cultured dough at a temperature and for a time sufficient to obtain a pH of about 5.2 to about 5.8, and mechanically working and cooking the cultured dough to form the mozzarella cheese. The invention specifies that the milk protein concentrate have a solubility of greater than about 50 percent and a whey protein content of less than about 15 percent (while whey protein content of milk is about 20 percent).

In recent years, there has been an increasing concern with the consumption of diet fat. Attempts, therefore, have been made to use skim or low fat milk in conventional cheese making processes to produce low fat cheeses. Unfortunately, the texture and flavor of the resulting low fat cheese products have not been entirely satisfactory for most consumers. Because fat contributes to a significant rule in the characteristic texture and flavor of conventional making cheese, the low-fat cheeses tend to be extremely hard, leathery and tough, and are often almost completely devoid of flavor. Therefore, it is a desideratum for a technology to make low fat cheese products having similar texture, flavor, and organoleptic properties when compared to their full fat counterparts.

According to USDA, American consumed about 4,075,000 tons of cheese products (source: national Committee of IDF, ZMP, USDA, The World Dairy situation 2002). Assuming that the average fat content in the cheese currently consumed is only 10 percent, Americans consume more than 400,000 tons of milk fat each year. If the fat content of cheese can be cut to 50 percent of current fat level, American could avoid the intake of over 200,000 tons of fat and save about 300 million of dollars annually. Thus, any improvements in the manufacture of hard cheese products that could reduce costs or improve qualitative characteristics would have significant economic value. It is well known in the prior art to produce low-fat cheeses from concentrated fluid milk by adding additives such as gum.

U.S. Pat. Nos. 5,532,018 and 5,709,900 describe a method for manufacture of low fat natural cheese with a gel-forming fat mimetic added to skim milk to provide a cheese substrate. The gel-forming fat mimetic, according to the invention, may be gelled in situ or may be pre-gelled.

U.S. Pat. No. 5,612,073 describes a method for manufacture of a low fat cheese curd product comprising an un-ripened enzyme clotted cheese curd formed from a starting skim milk, about 45-65% by weight water in said curd, a salt content of said curd of about 1-3% by weight, a milk protein content of said curd of about 32-55% by weight, and a calcium to protein ratio of said curd less than conventional skim milk curd. The low fat cheese curd product as defined above further including a stabilizer selected from the group consisting of gelatin, carrageenan, microcrystalline cellulose, carboxymethyl cellulose and mixtures thereof.

U.S. Pat. Nos. 5,080,913 and 5,225,220 describe a method for manufacture of a low fat cheese wherein liquid milk having a fat content of 0% to 0.3% is mixed with carrageenan and then a lactic acid produce is added to the mixture to form a cheese formulation solution.

U.S. Pat. No. 5,064,660 describes a method for the preparation of ultra low-fat cheese products by plasticizing a composition containing the desired low level of lipid, an amount of dairy protein, and from about 50% to about 70% moisture. The plasticization is achieved by subjecting the composition to the high speed cutting action of a razor sharp bladed food comminuter or to ultrasonic treatment to rupture the fat globules of the lipid and to reduce the particle size of the protein matrix, for a period of time sufficient to plasticize the composition. The physical changes which take place in the protein micelles and fat globules results in protein/fat interaction forming a stable self-emulsified product without the addition of chemical stabilizers or emulsifiers.

Accordingly, there has existed a definite need for an improved method for making a hard cheese with very similar textural, flavor, and compositional attributes as compared to conventionally prepared natural hard cheese. There has existed a further need for a no-whey process for preparing natural hard cheese, which can capture all whey proteins in cheese. There has existed a still further need for an improved method for preparing low-fat hard cheese product incorporated with all whey proteins. The current invention provides a technology for making low-fat hard cheese incorporated with all whey proteins, from which it eliminates the costly processing requirements of whey removal in conventional process.

### SUMMARY OF THE INVENTION

The object of the present invention is to eliminate the above-mentioned problems still associated with prior arts and to provide a method of preparing low-fat hard cheese, which has no whey generated from the milk and all whey proteins incorporated into product. In one embodiment, the present invention provides a no-whey process for preparing hard cheese from milk standardized with dry diary protein ingredients, said method comprising:
(1) mixing liquid milk and a dairy protein ingredient to form a blend, wherein the dry dairy ingredient is a modified milk protein concentrate, wherein the modified milk protein concentrate is a blend of about 82 to about 96 percent milk protein concentrate and up to about 18 percent a multifunctional dairy enzyme (IDEM series, Interface Protein Technology, Inc., Naperville, Ill.), and wherein the milk protein concentrate has a protein content of greater than 58 percent with all whey proteins retained in the product;
(2) optionally adding lactic acid or lactic acid-producing culture, and/or fat to the blend to obtain a pH of about 4.8 to about 5.8; and
(3) mechanically working and heating the blend at a temperature of about 130 to about 190 degree F. to form a hard cheese,
wherein the process converts all ingredients added into product and does not generate whey, and wherein the resulting cheese has organoleptic properties comparable to a natural hard cheese prepared in a conventional hard cheese process.

Preferably, the dry diary protein ingredient used in the present invention is a modified milk protein concentrate. More preferably, the modified milk protein concentrate is a highly functional cheese protein concentrate (CPC series, Interface Protein Technology, Inc., Naperville, IL). Optional ingredients such as salt, gums, supplements, preservatives, condiments, and the like may be incorporated into the cheese.

In another embodiment, the present invention provides a method for preparing low-fat hard cheese product with no whey generated and all whey proteins in the milk are incorporated into final product, said method comprising:
(1) mixing liquid milk and a dairy protein ingredient to form a blend, wherein the dry dairy ingredient is a modified milk protein concentrate, wherein the modified milk protein concentrate is a blend of about 82 to about 96 percent milk protein concentrate and up to about 18 percent a multifunctional dairy enzyme (IDEM series, Interface Protein Technology, Inc., Naperville, Ill.), and wherein the milk protein concentrate has a protein content of greater than 58 percent with all whey proteins retained in the product;
(2) optionally adding lactic acid or lactic acid-producing culture to the blend to obtain a pH of about 4.8 to about 5.8; and
(3) mechanically working and cooking the blend at a temperature of about 130 to about 190 degree F. to form a hard cheese,
wherein the process converts all ingredients added into product and does not generate whey, wherein the resulting hard cheese contain less than 5% of fat, and wherein the resulting hard cheese has organoleptic properties comparable to a natural hard cheese prepared in a conventional hard cheese process.

In another embodiment, the present invention provides a method for preparing modified milk protein concentrates that can be used for making a low fat hard cheese incorporated with all whey proteins, said method comprising mixing about 82 to about 96 percent milk protein concentrate and about 4 to about 18 percent multifunctional dairy enzyme to form a blend, wherein the multi-functional dairy enzyme is a blend of ingredients preferably selected from the group consisting about 2 to about 8.0 percent cheese flavor, about 2 to about 8.0 percent cheese powder, about 2 to about 8 percent salts, about 0.1 to about 3 percent lipase, about 0.01 to about 3 percent proteases, about 10 to about 60 percent emulsifiers, about 1.0 to about 8.0 percent calcium salts, about 3 to about 10 percent calcium caseinate, about 1 to about 6 percent lactic acid, and adequate amount of skim milk powder.

A principal advantage of the current invention is that it converts all milk proteins, including all whey proteins, into product from which no whey is generated. This eliminates the costly processing requirements of whey removal and solves the problem associated with the disposal of whey. In utilizing such a process, one pond of milk can produce about 1.4 ponds of cheese, which is about 14 times of production efficiency than conventional process.

Another advantage of the current invention is that it enables the production of healthier hard cheese with much less fat content. In utilizing such a process, it will eliminate the intake of about 200,000 tons of fat by Americans.

Another advantage of the current invention is that it eliminates separation of whey from the curd and significantly cut the production cycle. In utilizing the invented process, a low-fat hard cheese can be produced within about 30 minutes started from mixing the milk and dry dairy protein powder. The process, therefore, enables the incorporation of other nutrients, flavors, and supplements into the cheese. For example, ingredients such as poly-unsaturated fatty acids, vitamins, calcium, and other supplements can easily be incorporated into the product throughout the process.

### BRIEF DESCRIPTION OF THE DRAWINGS

FIG. 1 is a flowchart illustrating a preferred embodiment of the present invention.

FIG. 2 is a flowchart illustrating another embodiment of the present invention using a lactic acid culture.

### DETAILED DESCRIPTION OF THE INVENTION

The present invention relates to a method for producing a hard cheese utilizing modified milk protein concentrates. Particularly, the process of making a hard cheese has no whey generated and all whey proteins are captured in the cheese, wherein the hard cheese has texture and organoleptic properties comparable to a natural hard cheese prepared in a conventional process. More particularly, the present invention related to a method for producing a low fat hard cheese has no whey generated and all whey proteins are captured in the cheese, wherein the hard cheese has texture and organoleptic properties comparable to a natural hard cheese prepared in a conventional process. One particular embodiment of the present invention is that the process for making a hard cheese utilizing a modified milk protein concentrates, wherein the modified milk protein concentrate contains about 82 to about 96 percent milk protein concentrates and about 4 to about 18 percent multifunctional dairy enzyme to form a blend, wherein the multi-functional dairy enzyme is a blend of ingredients preferably selected from the group consisting about; 2 to about 8.0 percent cheese flavor, about 2 to about 8.0 percent cheese powder, about 2 to about 8 percent salts, about 0.1 to about 3 percent lipase, about 0.01 to about 3 percent proteases, about 10 to about 60 percent emulsifiers, about 1.0 to about 8.0 percent calcium salts, about 3 to about 10 percent calcium caseinate, about 1 to about 6 percent lactic acid, and adequate amount of skim milk powder.

While it is believed that when whey protein above about 15 percent interferes with the alignment of casein molecules into the fibers required for good mozzarella texture (U.S. Pat. No. 6,372,268), the discovery of present invention has created solutions to incorporate all whey proteins in the cheese system without interfering the stretching texture of a mozzarella cheese. Therefore, the most significant difference of the present invention from all prior art is that the present invention allows the capture of all whey proteins in the milk system, including the added milk protein concentrate, to make good hard texture, such as mozzarella cheese. In utilizing the principle of the present invention, all hard cheese products such as mozzarella cheese, Cheddar cheese, Parmesan cheese, and other processed cheese products can be produced with no whey generated and all whey proteins captured without compromising the texture and organoleptic properties of the product.

The dry dairy protein ingredient used in the present invention relates to milk protein concentrates prepared using membrane ultrafiltration of skim (or whole) milk to remove water, salts and lactose. Diafiltration with water may be used to further reduce these components. Essentially all of the casein and whey proteins (and fat, if present) are retained in the retentate by a membrane with a 10,000 to 8,000 molecular weight cut-off. The retentate is then spray-dried to make milk protein concentrate powders. One of the advantages of the present invention is that almost all commercially available milk protein concentrates can be used to make the low fat hard cheese when modified with a multifunctional dairy enzyme (IDEM series, Interface Protein Technology, Inc., Naperville, Ill.).

Another embodiment of the present invention is that the multifunctional dairy enzyme is a blend of ingredients preferably selected from the group consisting about 2 to about 8.0 percent cheese flavor, about 2 to about 8.0 percent cheese powder, about 2 to about 8 percent salts, about 0.1 to about 3 percent lipase, about 0.01 to about 3 percent proteases, about 10 to about 60 percent emulsifiers, about 1.0 to about 8.0 percent calcium salts, about 3 to about 10 percent calcium caseinate, about 1 to about 6 percent lactic acid, and adequate amount of skim milk powder. The multifunctional dairy enzyme is a sophisticated multifunctional system that modifies the functionality of dairy proteins at the interface of cheese system while generating specific cheese flavors. The multifunctional enzyme system, when mixes with a milk protein concentrate, enables the conversion of all dairy materials including all whey proteins into a hard cheese product without compromising the texture and organoleptic properties of the resulting product.

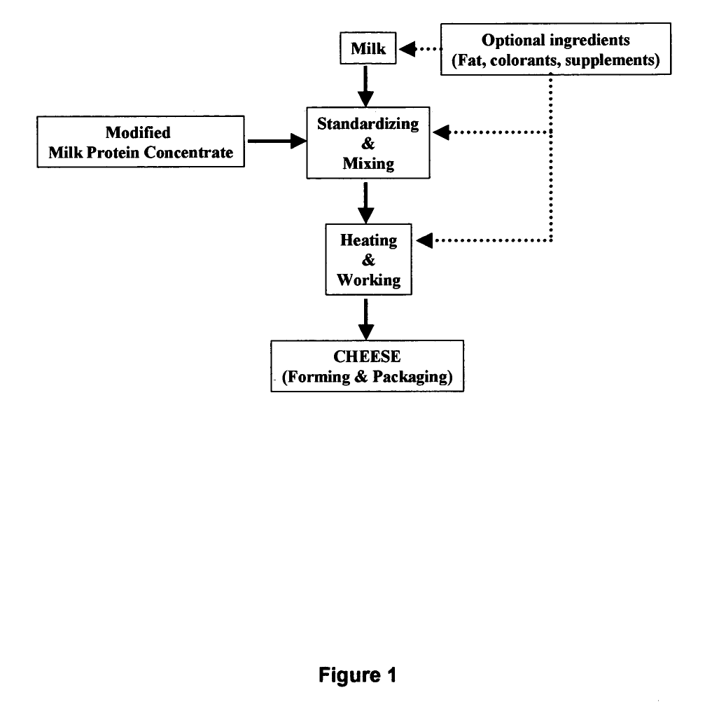

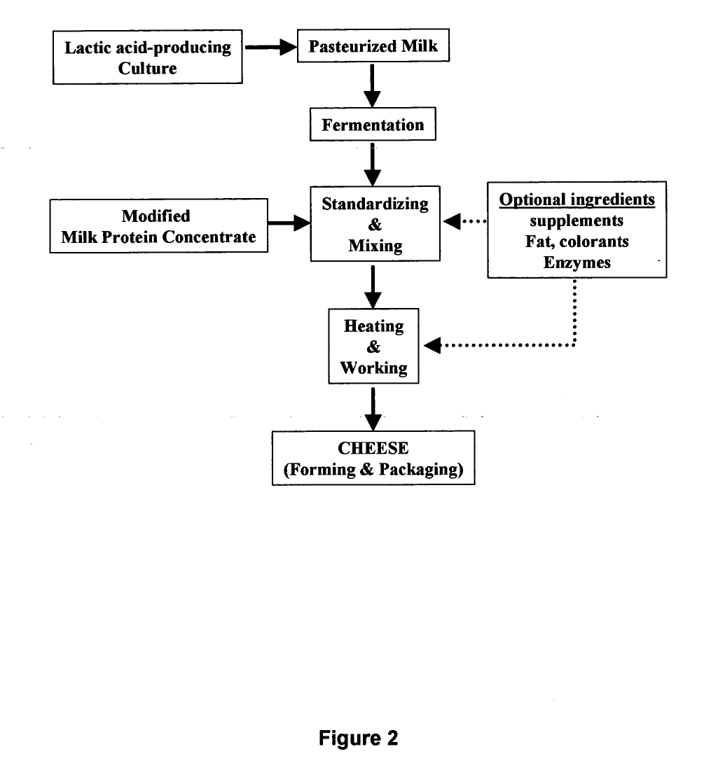

FIGS. 1, and 2 illustrate several embodiments of the present invention. The process illustrated in FIG. 1 is a non-culturing process using a whole milk as the liquid phase standardized with a modified milk protein concentrate. The process illustrated in FIG. 2 is a culturing process using a whole milk as the liquid phase, fermented with a lactic acid-producing culture, and standardized with a modified milk protein concentrate to make cheese. Generally, whole milk using the lactic acid-producing culture method is preferred because better flavor profiles can be obtained from it.

FIG. 1 illustrates a preferred embodiment of the process of the present invention using a modified milk protein concentrate. A whole milk is standardized with a modified milk protein concentrate. Salt, lactic acid, as well as other optional ingredients, can be added to the mixture. If appropriate, additional dairy fat may be added to adjust the fat content of the final cheese. Generally, the standardized milk blend contains about 18 to about 32 percent proteins. The dry dairy protein ingredient generally contains about 50 to 78 percent milk protein. Suitable commercially available modified milk protein concentrates include, for example, CPC product series (Interface Protein Technology, Inc. Naperville, Ill.). The dry dairy protein powder is added with stirring until the powder is uniformly wetted.

The standardized dairy mixture is than heated and mechanically worked to achieve the desired texture of a cheese product. A typical device that can be used for heating and mixing is a “lay-down cooker” (e.g., Damrow, Fond du Lac, Wis.) having a single auger or twin-screw augers for mechanically working the cheese and steam jets for directly heating the dairy mixture. Optional ingredients may be added to the cooker include, for example, colorants at about 0.01 to about 1 percent; anti-microbials or preservatives (e.g., potassium sorbate, sorbic acid, benzoic acid, and the like) at about 0.05 to about 0.2 percent; flavors, both natural and artificial, at about 0.02 to about 1 percent; hydrocolloid gums (e.g., calcium caseinate, sodium caseinate, carrageenan, sodium carboxymethylcellulose, modified starch, and the like) at about 0.1 to about 1 percent; vitamins, minerals, and other supplements (e.g., poly-unsaturated fatty acids, nutritional peptides, essential aminal acids, and the like) at about 0.5 to about 2 percent.

The above mixture is heated to about 130 to about 190 degree F., and more preferably to about 155 to about 175 degree F., with continuous mixing and working. The heated cheese is held at this temperature for about 0.2 to about 10 minutes, preferably less than 1 minute, to complete the heating and working process.

The resulting low fat hard cheese is then collected and packaged using conventional techniques. For example, the cheese can be hot-packed in lined boxes, tubs, or other suitable containers. The cheese can also be chill-rolled and cold packed, or packaged using an extrusion device (e.g., Hantmann extruder) to extrude it into various desired shapes.

Another embodiment of the present invention is shown in FIG. 2. This embodiment relies upon the addition of a lactic-acid producing culture to convert lactose into lactic acid for lowering the pH of milk and to generate more culturing flavors. If appropriate, additional dairy fat may be added to adjust the fat content of the final cheese. The milk is then Pasteurized and cool down to about 89 degree F. A lactic acid-producing culture or mixture of lactic acid-producing cultures is added at a concentration of about 0.001 to about 0.1 percent with mixing. Suitable lactic acid-producing cultures are well known in the cheese-making art and include, for example, Chymosin (Chymax 2X; Chr. Hansen, Inc., Milwaukee, Wis.), DVS cultures such as Stc4, Yofast 15, and LH32 (Chr. Hansen, Inc.), and the like. The milk is held at a temperature and for a time sufficient to allow the pH to drop to about 4.4 to about 5.1. The temperature required for the fermentation depends on the specific lactic acid producing culture used. For example, if the lactic acid-producing culture is thermophilic, a temperature of about 92 to about 125 degree F., if the lactic acid-producing culture is a mesophilic, a temperature of about 65 to about 95 degree F. would be acceptable. Typically, under these conditions, the pH will reach the desired level in about 3 to about 8 hours. The pH drop is due to the action of the culture that converts lactose to lactic acid (plus flavor components).

Once the pH reaches the desired level, a dry milk protein powder is added to standardize the system to reach the targeted protein, fat, and moisture level. The dry dairy protein ingredient generally contains about 50 to 78 percent milk protein. Suitable commercially available modified milk protein concentrates include, for example, CPC product series (Interface Protein Technology, Inc. Naperville, Ill.). Salt, as well as other optional ingredients, can be added to the mixture. Generally, the standardized milk blend contains about 16 to about 32 percent proteins. The dry dairy protein powder and/or other optional ingredients are added with stirring until the powder is uniformly wetted. The standardized dairy mixture is than heated and mechanically worked to achieve the desired texture of a cheese product. Optional ingredients may be added to the cooker include, for example, hydrocolloid gums (e.g., calcium caseinate, sodium caseinate, carrageenan, sodium carboxymethylcellulose, modified starch, and the like) at about 0.1 to about 1 percent; flavors, both natural and artificial, at about 0.02 to about 1 percent; colorants at about 0.01 to about 1 percent; anti-microbial or preservatives (e.g., potassium sorbate, sorbic acid, benzoic acid, and the like) at about 0.05 to about 0.2 percent; vitamins, minerals, and other supplements (e.g., poly-unsaturated fatty acids, nutritional peptides, essential amino acids, and the like) at about 0.5 to about 2 percent.

The above mixture is heated to about 130 to about 190 degree F., and more preferably to about 155 to about 175 degree F., with continuous mixing and working. The heated cheese is held at this temperature for about 0.2 to about 10 minutes, preferably less than 1 minute, to complete the heating and working process.

The resulting low fat mozzarella style cheese is then collected and packaged. using conventional techniques. For example, the cheese can be hot-packed in lined boxes, tubs, or other suitable containers. The cheese can also be chill-rolled and cold packed, or packaged using an extrusion device (e.g., Hantmann extruder) to extrude it into various desired shapes.

Definitions. The definitions of a number of terms and phrases used in the present application are provided.

As used herein, “milk protein concentrate” relates to milk protein concentrates prepared using either membrane ultrafiltration of skim (or whole) milk to remove salts, water, lactose and other non-protein materials. Diafiltration with water may be used to further reduce these non-protein components. Essentially all of the caseins and whey proteins (and fat, if present) are retained in the retentate by a membrane with a 10,000 to 6,000 molecular weight cut-off. The retentate is then spray-dried to make milk protein concentrate powders. Most commercially available milk protein concentrates contain more than 56 percent of proteins among them about 20 percent are whey proteins and the rest are caseins.

As used herein, “whey proteins” relate to the proteins contained in a dairy liquid obtained as a supernatant of the curds when milk or a product containing milk components is curded to produce a semisolid cheese curd. Whey proteins generally include principally the globular proteins□ β-lactoglobulin and α-lactalbumin; it also includes a significantly lower concentration of albumin, immunoglobulin, and other globulins. Typical ratio of whey protein to casein in a milk system is at about 20 to 80 (20% of proteins in the milk are whey proteins). In conventional cheese making process, most of whey proteins are remain in the whey and thus become processing waste. Because whey proteins are highly hydrophilic global proteins, it is generally believed that in cheese system when whey protein reach about 15 percent interferes with the alignment of casein molecules into the fibers required for good chicken-breast texture of hard cheeses such as mozzarella texture (U.S. Pat. No. 6,372,268). Whey proteins have recently been recognized as high nutritional components that should be recovered from conventional cheese making process.

The following examples describe and illustrate the methods and compositions of the invention. The examples are intended to be merely illustrative of the present invention, and not limiting thereof in either scope or spirit. Those skilled in the art will readily understand that variations of the materials, conditions, and processes described in these examples can be used. Unless indicated otherwise, all percentages are by weight.

### EXAMPLE 1

### A Low-Fat Mozzarella Style Cheese Having a 20/80 Ratio of Whey Protein to Casein is Prepared by the Following Method

1) Mixing 1.91 pounds of 2% reduced fat milk, 1.00 pounds of modified milk protein concentrate (CPC-1, Interface Protein Technology, Inc. Naperville, Ill.), and 0.01 lb of lactic acid (88% acid) at room temperature in a blender (Artisan, Max Watts 325, St. Joseph, Mich.) for 5 minutes.

2) Merging the blender into a hot water bath to heat the resulting slurry in the blender to about 168 degree F., and hold at the temperature for 30 seconds.

3) Removing the melted cheese and packing into containers (0.5 lb each).

4) Evaluating the cheese after 3 days of storage at refrigerator.

The resulting cheese has a fat content much lower than part skim mozzarella cheese as summarized in Table-1. While the resulting cheese has all whey proteins captured, results from a small testing panel indicate that the cheese had texture, flavor, and melting characteristics similar to commercial LMPS mozzarella cheese in side-by-side pizza baking tests.

TABLE 1
Key compositions of the mozzarella cheese products

| | Mozzarella cheese | | |
|---|---|---|---|
| | The Inven- | Part Skim | |
| Composition | tive Product | Milk | Whole Milk |
| Total Lipid (Fat) % | 2.0 | 15.9 | 22.4 |
| Protein % | 24.8 | 24.3 | 22.2 |
| Whey protein % | 20 | <5 | <5 |
| Water % | 58 | 53.8 | 50 |
| Cholesterol (mg/100 g) | <10 | 64 | 79 |

| | | |
|---|---|---|
| Information Source | Calculation | USDA National Nutrient Database |

### EXAMPLE 2

### A Cheddar-Style Cheese With all Whey Proteins Captured is Prepared by the Following Method

1) Mixing 1.89 lb of whole milk (Safeway Inc., Pleasanton, Calif.), 0.55 lb melted anhydrate butter fat, and 1.08 pounds of modified milk protein concentrate (CPC-2, Interface Protein Technology, Inc. Naperville, Ill.) at room temperature in a blender (Artisan, Max Watts 325, St. Joseph, Mich.) for about 10 minutes and hold for about 30 minutes.

2) Merging the blender into a hot water bath to heat the resulting slurry in the blender to about 158 degree F., and hold at the temperature for 10 seconds.

3) Removing the melted cheese and packing into containers (0.5 lb each).

4) Immediately cool down the packed cheese and stored in a refrigerator for 3 days before evaluating the resulting cheese.

While the resulting cheese has all whey proteins captured, results from a small testing panel indicate that the cheese had texture, flavor, and melting characteristics similar to commercial full fat cheddar cheese. Specifically, the melting property of the resulting cheese is even slightly better than full fat commercial cheddar cheese.

### EXAMPLE 3

### A Parmesan-Style Cheese With all Whey Proteins Captured is Prepared by the Following Method

1) Mixing 2.58 lb of whole milk (Safeway Inc., Pleasanton, Calif.) with about 0.8 g of LH32 and 1.2 g of Stc4 (Chr. Hansen, Milwaukee, Wis.).

2) Incubating the cultured milk at about 110 degree F. for about 5 hours to drop pH to about 4.8.

3) Mixing the above fermented milk with 0.69 lb of melted anhydrate butter fat, and 1.39 pounds of modified milk protein concentrate (CPC-3, Interface Protein Technology, Inc. Naperville, Ill.) at room temperature in a blender (Artisan, Max Watts 325, St. Joseph, Mich.) for about 10 minutes and hold for about 60 minutes.

4) Merging the blender into a hot water bath to heat the resulting slurry in the blender to about 153 degree F., and hold at the temperature for 10 seconds.

5) Removing the melted cheese and packing into containers (0.5 lb each).

6) Immediately cool down the packed cheese and stored in a refrigerator for 3 days before evaluating the resulting cheese.

While the resulting cheese has all whey proteins captured and is produced within a day without going through a ripening process, results from a small testing panel indicate that the cheese had texture and flavor characteristics similar to commercial Parmesan cheese. Another advantage for utilizing the present invention for making Parmesan cheese is that it enables the incorporation of other supplements into cheese to make nutrients fortified Parmesan cheese.

1. A method for preparing a hard cheese without whey separation, said method comprising:
(1) mixing liquid milk and a dairy protein ingredient to form a blend, wherein dairy fat can optionally be added to the milk, wherein a lactic acid-producing dairy culture can optionally be added to the milk to convert lactose into lactic acid and generate more flavors, and wherein the dairy protein ingredient is a modified milk protein concentrate, and;
(2) mechanically working and heating the blend at a temperature of about 130 to about 190 degree F. to form a cheese, wherein optional ingredients such as gum and other supplements can be added during the heating process; and
(3) collecting the cheese,
wherein the process does not generate processing waste or whey, wherein all milk and the added dairy protein ingredients are converted into cheese with all whey proteins captured, and wherein the hard cheese has texture and organoleptic properties comparable to a natural hard cheese prepared in a conventional process.

2. The method of claim 1, wherein the dairy protein ingredient is a modified milk protein concentrate having a protein content of greater than 50 percent, and wherein the resulting cheese have all whey proteins captured.

3. The method of claim 1, wherein the blend of milk and dairy protein ingredient is heated to about 130 to about 190 degree F., and more preferably to about 155 to 175 degree F., with continuous mixing and working.

4. The method of claim 1, wherein the mixture of milk and dairy protein ingredient is heated to about 155 to about 175 degree F., held at the temperature for about 0.2 to about 10 minutes, preferably less than 2 minute, to complete the heating and working process.

5. The method of claim 1, wherein the hard cheese is a mozzarella cheese having texture and organoleptic properties comparable to a natural mozzarella cheese prepared in a conventional mozzarella process.

6. The method of claim 5, wherein the mozzarella cheese is a low-fat product having texture and organoleptic properties comparable to a natural mozzarella cheese prepared in a conventional mozzarella process.

7. The method of claim 5, wherein the mozzarella cheese has all whey proteins captured with a ratio of whey protein to casein up to 20/80 and having texture and organoleptic properties comparable to a natural mozzarella cheese prepared in a conventional mozzarella process.

8. The method of claim 1, wherein the hard cheese is a cheddar-style cheese having texture and organoleptic properties comparable to a natural cheddar cheese prepared in a conventional cheddar process.

9. The method of claim 8, wherein the cheese is a low fat cheddar-style cheese with all whey proteins captured and having texture and organoleptic properties comparable to a natural cheddar cheese prepared in a conventional cheddar process.

10. The method of claim 1, wherein the product is a hard cheese made from milk and a dairy protein ingredient, wherein the hard cheese has all whey proteins captured.

11. The method of claim 10, wherein the hard cheese is a low fat hard cheese containing less than 60 percent moisture and all whey proteins are captured, and wherein the all whey captured low fat hard cheese having texture and organoleptic properties comparable to a natural hard cheese prepared in a conventional process.

12. A method for preparing modified milk protein concentrate that can be used for making all whey proteins incorporated hard cheese without whey separation, said method comprising mixing about 82 to about 96 percent milk protein concentrate and about 4 to about 18 percent multifunctional dairy enzyme to form a blend, wherein the milk protein concentrate has a protein content of greater than 55 percent, and wherein the multi-functional dairy enzyme is a blend of ingredients preferably selected from the group consisting about 2 to about 8.0 percent cheese flavor, about 2 to about 8.0 percent cheese powder, about 2 to about 8 percent salts, about 0.1 to about 3 percent lipase, about 0.01 to about 3 percent proteases, about 10 to about 60 percent emulsifiers, about 1.0 to about 8.0 percent calcium salts, about 3 to about 10 percent calcium caseinate, about 1 to about 6 percent lactic acid, and adequate amount of skim milk powder.

13. The method of claim 12, wherein the multifunctional dairy enzyme system is a mixture of proteases, peptidases, lipases, lactase, and other intrinsic enzymes from cultured milk, wherein the protease is present at about 0.001 to about 0.5 percent, wherein the lipase is present at about 0.0001 to about 0.2 percent, and wherein lactase and other intrinsic enzymes are present at about 0.01 to about 2.0 percent.

14. The method of claim 12, wherein the multifunctional dairy enzyme system is a mixture of salts and emulsifiers, wherein the salts include calcium salts, potassium salts, and sodium salts and are present at about 3 to 16 percent, wherein the emulsifiers include sodium citrate, calcium phosphate, potassium phosphate, sodium phosphate and are present at about 10 to 60 percent as a mixture of them.
